(19) United States
(12) Patent Application Publication
(10) Pub. No.: US 2019/0126840 A1
(43) Pub. Date: May 2, 2019

(54) BUMPER-CARRIER ASSEMBLY FOR VEHICLE

(71) Applicant: James Patrick GROSSAINT, Bellflower, CA (US)

(72) Inventor: James Patrick GROSSAINT, Bellflower, CA (US)

(73) Assignee: Wheel Group Holdings, LLC, Ontario, CA (US)

(21) Appl. No.: 15/801,122

(22) Filed: Nov. 1, 2017

(51) Int. Cl. B60R 9/06

(52) U.S. Cl. CPC B60R 9/06; B60R 2011/004

(57) ABSTRACT

The present invention is directed to a device for use on a vehicle including a bumper body assembly, the bumper body assembly, a swing arm assembly, the swing arm assembly including a rack providing a front-side carrier and a rear-side carrier; and a post kit, the post kit corresponding to the first cavity in the bumper body assembly. The swing arm assembly is detachably attached to the bumper body assembly with the post kit and the swing arm assembly is swingable about the post kit and swingable away from the bumper body assembly. The device of the present invention can further include a retraction mechanism and/or a locking mechanism for moving the swing arm assembly in a controlled manner. The front-side carrier can be an auxiliary gasoline can holder, and the rear-side carrier can be a spare tire holder.

### BACKGROUND OF THE INVENTION

### Field of the Invention

In general, the present invention relates to a carrier assembly, and, more specifically, to a carrier assembly that can be attached to an exterior of a vehicle, has a pivoting arm, and provides auxiliary storage or carrying capability.

### Discussion of the Related Art

A motor vehicle typically has a trunk to provide storage. In general, a compact car, a sport utility vehicle or an off-road vehicle has a small trunk or does not have a trunk. Such a vehicle provides limited or no storage space. A need therefore exists for a detachable carrier assembly that can be attached to an exterior of a vehicle, for example, a vehicle bumper, to provide auxiliary carrying capability, without obstructing access to the vehicle.

### SUMMARY OF THE INVENTION

Accordingly, embodiments of the invention are directed to carrier assemblies that substantially obviate one or more of the problems due to limitations and disadvantages of the related art.

An object of embodiments of the invention is to provide a carrier assembly that provides auxiliary storage or carrying capability.

Another object of embodiments of the invention is to provide a carrier assembly that can be detachably mounted to a vehicle bumper.

Yet, another object of embodiments of the invention is to provide a carrier assembly that is capable to be pivoted to allow access to the vehicle without removing the carrier assembly or any carriage on the carrier assembly.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a device includes a bumper body assembly, the bumper body assembly including a first base, a second base, and a first cavity, the first base being higher than the second base; a swing arm assembly, the swing arm assembly including a rack providing a front-side carrier and a rear-side carrier; and a post kit, the post kit corresponding to the first cavity in the bumper body assembly, wherein the swing arm assembly is detachably attached to the bumper body assembly with the post kit and the swing arm assembly is swingable about the post kit and swingable away from the bumper body assembly.

In another embodiment of the invention, as embodied and broadly described, a device, comprising: a bumper, the bumper including a first base, a second base, and a first cavity, the first base being higher than the second base and the first cavity in a first end of the bumper; a pivoting arm assembly, the pivoting arm assembly including a rack providing a front-side carrier and a rear-side carrier; and a post, the post corresponding to the first cavity in the bumper, wherein the pivoting arm assembly is detachably attached to the bumper with the post and the pivoting arm assembly pivots about the post and away from a second end of the bumper.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1A is a perspective view illustrating a carrier assembly according to an embodiment of the present invention being attached to a rear end of a vehicle and in a closed position.

FIG. 1B is another perspective view illustrating the carrier assembly illustrated in FIG. 1A.

FIG. 1C is an exploded view illustrating an end of the carrier assembly illustrated in FIG. 1A.

FIG. 2 is a perspective view illustrating a carrier assembly according to an embodiment of the present invention being attached to a rear end of a vehicle and in an open position.

FIG. 3 is a perspective view illustrating a swing arm of a carrier assembly according to another embodiment of the present invention.

FIG. 4A, FIG. 4B, and FIG. 4C are perspective views illustrating an arm assembly for a carrier assembly according to an embodiment of the present invention.

FIG. 5A, FIG. 5B, and FIG. 5C are perspective views illustrating a bumper assembly for a carrier assembly according to an embodiment of the present invention.

FIG. 6 is a perspective view illustrating a post for a carrier assembly according to an embodiment of the present invention.

### DETAILED DESCRIPTION OF THE PREFERRED EMBODIMENTS

Reference will now be made in detail to the preferred embodiments of the invention, examples of which are illustrated in the accompanying drawings.

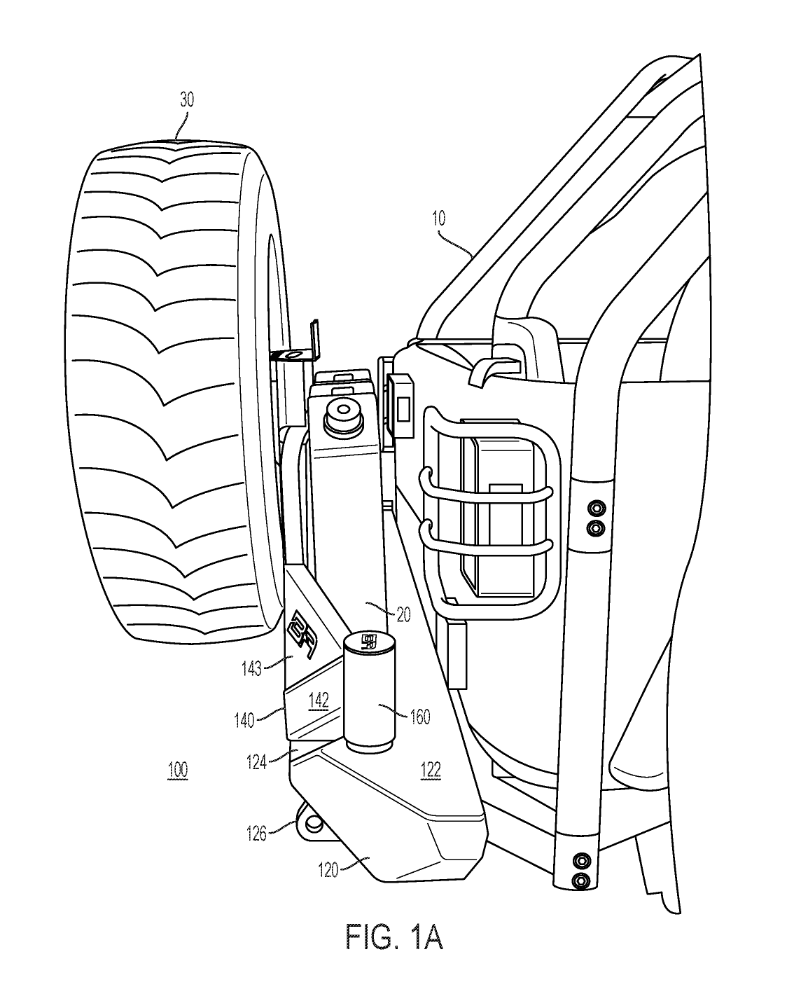

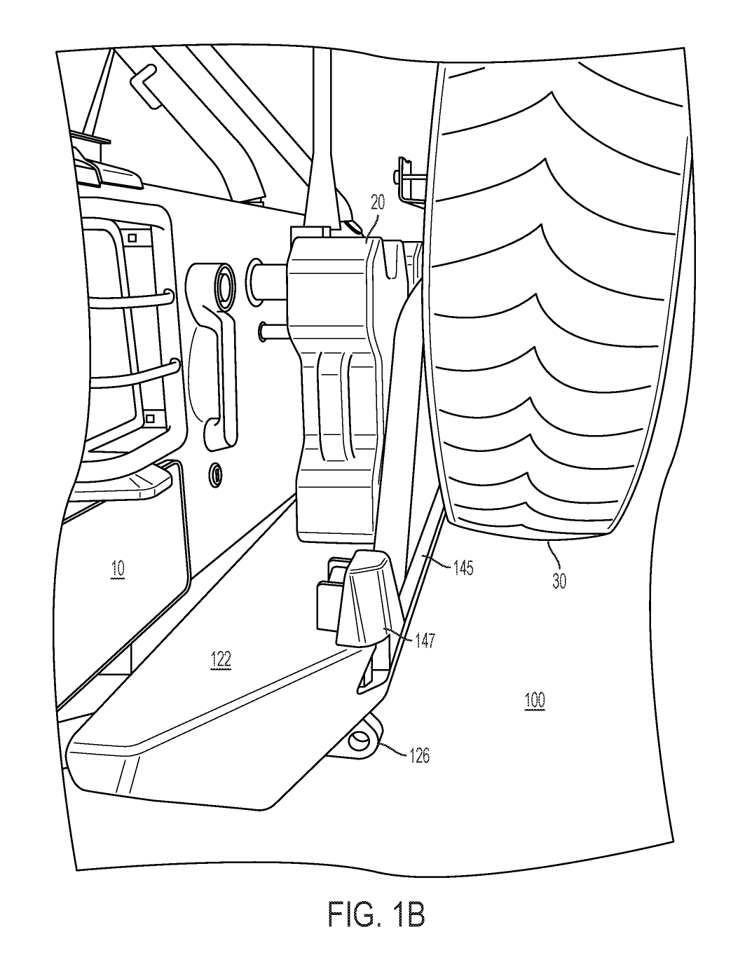

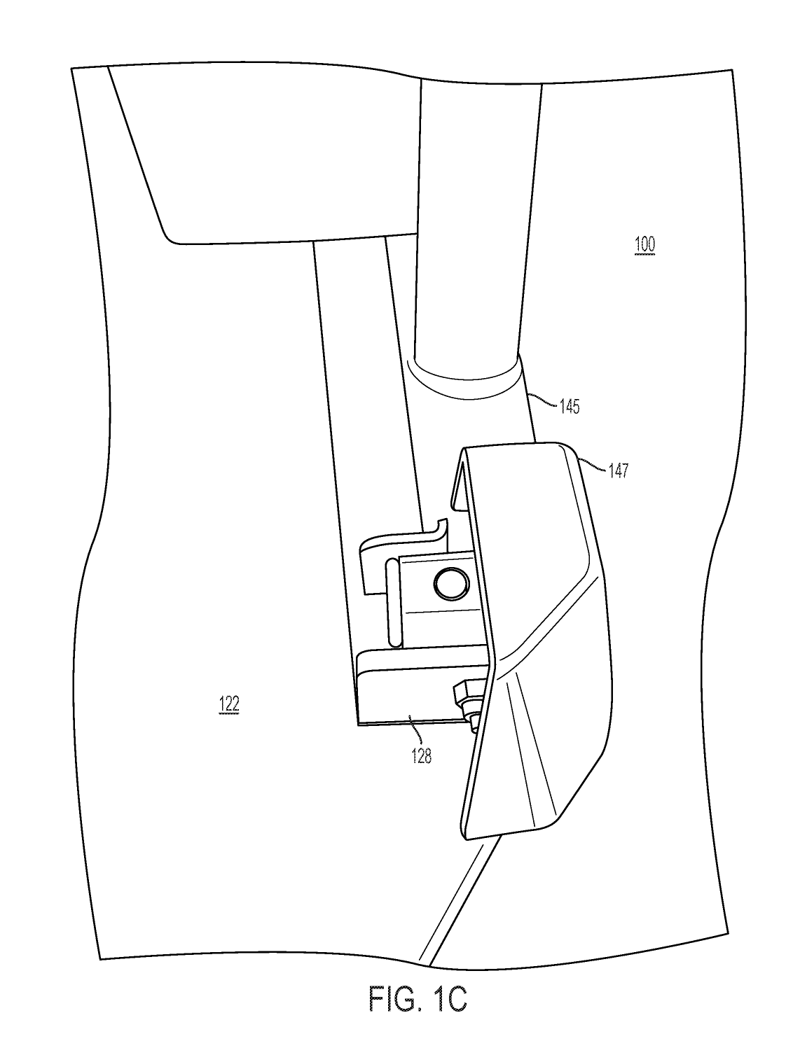

FIG. 1A is a perspective view illustrating a carrier assembly according to an embodiment of the present invention being attached to a rear end of a vehicle and in a closed position. As illustrated in FIG. 1A, a carrier assembly 100 includes a bumper assembly 120 and an arm assembly 140. A post assembly 160 rotatably attaches the arm assembly 140 with the bumper assembly 120. The arm assembly 140 can swing about the post assembly 160 relative to the bumper assembly 120. As the arm assembly 140 is swung about the post assembly 160, the arm assembly 140 moves away from the bumper body assembly 120. In an embodiment, the arm assembly 140 can swing about the post assembly 160 between 0° to ˜90°, for example, 90° and 100°. In another embodiment, the arm assembly 240 can swing about the post assembly 260 between 0° to more than 100°, for example 120°.

The bumper assembly 120 can be detachably attached to an exterior of a vehicle 10. For example, the bumper assembly 120 is detachably attached to a rear end of the vehicle 10. The bumper assembly 120 may replace a factory bumper (not shown) to a vehicle 10. The bumper assembly 120 may be attached to the rear end of the vehicle 10 at the same position and in the same manner as a factor bumper (not shown) would be attached to the vehicle 10.

The bumper assembly 120 includes a first base 122 and a second base 124. The first base 122 and the second base 124 are substantially parallel with one another. The first base 122 and the second base 124 have tiered planes. For example, the first base 122 has a higher plane than the second base 124.

The bumper assembly 120 also includes one or more built-in strike plates or shackle mounts 126. The mounts 126 may extend from a side under the second base 124. With the first and second bases 122 and 124 having tiered planes and by incorporating the mounts 126 or another type of mounting mechanisms from an underside of the bumper assembly 120, clearance can be provided for the objects to be attached to or carried through the shackle mounts or another type of mounting mechanisms from the arm assembly 140.

The arm assembly 140 includes multiple carrier capacities to provide flexible and large auxiliary carrying capabilities. For example, the arm assembly 140 may simultaneously hold one or more auxiliary gasoline cans 20 on the front side of the arm assembly 140, and a spare tire 30 on the rear side of the arm assembly 140. As illustrate in FIG. 1a, when the arm assembly 140 is in a closed position, the main body of the arm assembly 140 is substantially parallel to the first base 122 of the bumper body assembly 120 and the main body of the arm assembly 140 is suspended above the second base 124 of the bumper body assembly 120.

The arm assembly 140 includes a first arm 142, and a side plate 143. The side plate 143 extends substantially vertically from the first arm 142. The first arm 142 and the side plate 143 are suspended above the first base 122 and the second base 124 of the bumper body assembly 120. The rear surface of the side plate 143 may provide a display surface for displaying a logo or decal. When the arm assembly 140 is in the close position, the side plate 143 extends at an angle relative to the first base 122 and the second base 124 of the bumper body assembly 120. The side plate 143 preferably extends from an outer edge of the first base 122 of the bumper body assembly 120, across the length of the second base 124 of the bumper body assembly 120, to an outer edge of the second base 124 of the bumper body assembly 120. In addition, the angling of the side plate 143 provides additional space for a front-side carrier of the arm assembly 140. For example, as illustrate in FIG. 1A, the angling of the side plate 143 accommodates the thickness of the auxiliary gasoline can 20.

FIG. 1B is another perspective view illustrating the carrier assembly illustrated in FIG. 1A, and FIG. 1C is an exploded view illustrating an end of the carrier assembly illustrated in FIG. 1A. As illustrated in FIG. 1B, the arm assembly 140 includes a second arm 145. The second arm 145 is a primary arm of the arm assembly 140. The second arm 145 is suspended above the first base 122 and the second base 124 of the bumper body assembly 120. When the carrier assembly 100 is in the closed position, the second arm 145 is aligned substantially parallel to the first base 122.

As illustrated in FIG. 1B, a first end of the primary arm 145 is attached to the first arm 142 and the side plate 143. As illustrated in FIG. 1C, a second, opposing end of the primary arm 145 is attached to a stop bracket 147. The stop bracket 147, along with an upper strike plate 128 of the bumper assembly 120 and a locking bolt (not shown), can secure the arm assembly 140 in a closed position.

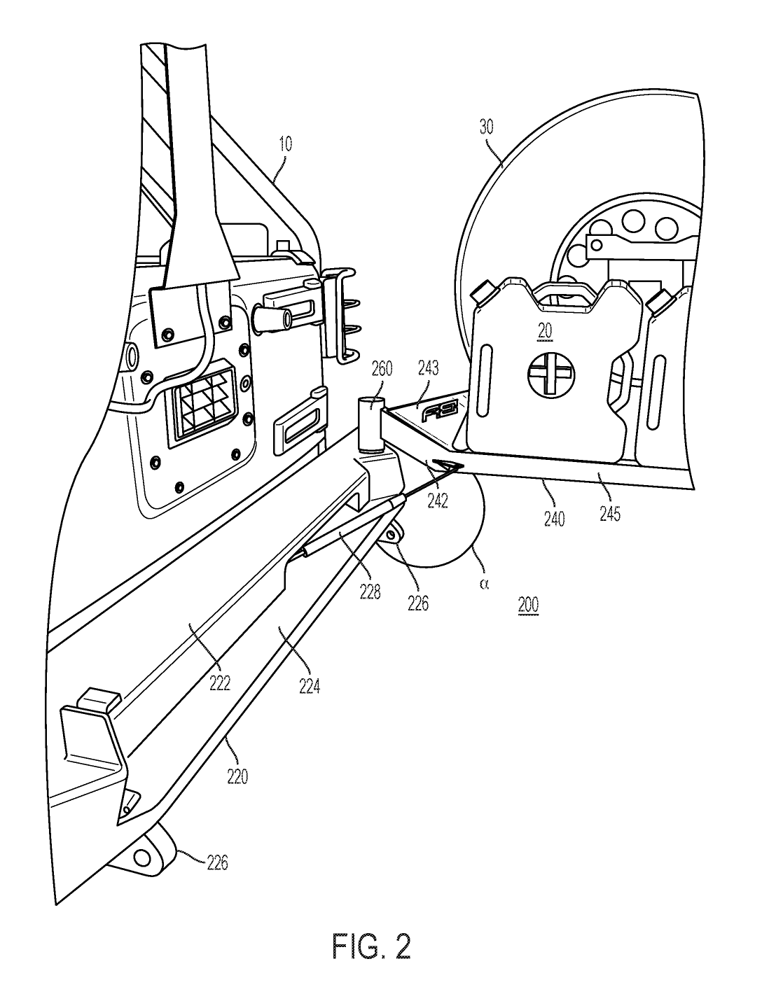

FIG. 2 is a perspective view illustrating a carrier assembly according to an embodiment of the present invention being attached to a rear end of a vehicle and in an open position. As illustrated in FIG. 2, a carrier assembly 200 includes a bumper assembly 220 and an arm assembly 240. A post assembly 260 rotatably attaches the arm assembly 240 with the bumper assembly 220. The arm assembly 240 can swing about the post assembly 260 relative to the bumper assembly 220.

The bumper assembly 220 can be detachably attached to an exterior of a vehicle 10. For example, the bumper assembly 220 is detachably attached to a rear end of the vehicle 10. The bumper assembly 220 may replace a factory bumper (not shown) to a vehicle 10. The bumper assembly 220 may be attached to the rear end of the vehicle 10 at the same position and in the same manner as a factor bumper (not shown) would be attached to the vehicle 10.

The bumper assembly 220 includes a first base 222 and a second base 224. The first base 222 and the second base 224 are substantially parallel with one another. The first base 222 and the second base 224 have tiered planes. For example, the first base 222 has a higher plane than the second base 224.

The bumper assembly 220 also includes one or more built-in strike plates or shackle mounts 226. The mounts 226 may extend from a side under the second base 224. With the first and second bases 222 and 224 having tiered planes and by incorporating the mounts 226 or another type of mounting mechanisms from an underside of the bumper assembly 220, clearance can be provided for the objects to be attached to or carried through the shackle mounts or another type of mounting mechanisms from the arm assembly 240.

The arm assembly 240 includes multiple carrier capacities to provide flexible and large auxiliary carrying capabilities. For example, the arm assembly 240 may simultaneously hold one or more auxiliary gasoline cans 20 on the front side of the arm assembly 240, and a spare tire 30 on the rear side of the arm assembly 240.

The arm assembly 240 includes a first arm 242, and a side plate 243. The side plate 243 extends substantially vertically from the first arm 242. The first arm 242 and the side plate 243 are suspended above the first base 222 and the second base 224 of the bumper body assembly 220. The rear surface of the side plate 243 may provide a display surface for displaying a logo or decal. When the arm assembly 240 is in the close position (not shown), the side plate 243 extends at an angle relative to the first base 222 and the second base 224 of the bumper body assembly 220. The side plate 243 preferably extends from an outer edge of the first base 222 of the bumper body assembly 220, across the length of the second base 224 of the bumper body assembly 220, to an outer edge of the second base 224 of the bumper body assembly 220. In addition, the angling of the side plate 243 provides additional space for a front-side carrier of the arm assembly 240.

The arm assembly 240 further includes a second arm 245. The second arm 245 is a primary arm of the arm assembly 240. The second arm 245 is suspended above the first base 222 and the second base 224 of the bumper body assembly 220. A first end of the primary arm 245 is attached to the first arm 242 and the side plate 243.

FIG. 2 illustrates the carrier assembly 200 in an open position. When the carrier assembly 200 is in an open position, the arm assembly 240 swings about the post assembly 260 and away from the bumper body assembly 220. In an embodiment, the arm assembly 240 can swing about the post assembly 260 at an angle α. The angle α is between 0° to ˜90°, for example, 90° and 100°. In another embodiment, the angle α is between 0° to more than 100°, for example 120°.

The bumper assembly 220 may further include a retractor 228. The retractor 228 keeps the arm assembly 240 with a tension, as the arm assembly 240 swings about the post assembly 260 and away from the bumper body assembly 220. In addition, the retractor 228 holds the arm assembly 240 at the fully open position, when the rotation angle α is at maximum. The retractor 228 may include a spring mechanism (not shown) that retracts the arm assembly 240 toward back to the bumper body assembly 220. The spring mechanism (not shown) may retract the arm assembly 240 in a controlled manner. The retractor 228 is retrieved and stays within the bumper assembly 220, when the carrier assembly 200 is in the closed position and when the second arm 245 is aligned substantially parallel to the first base 222.

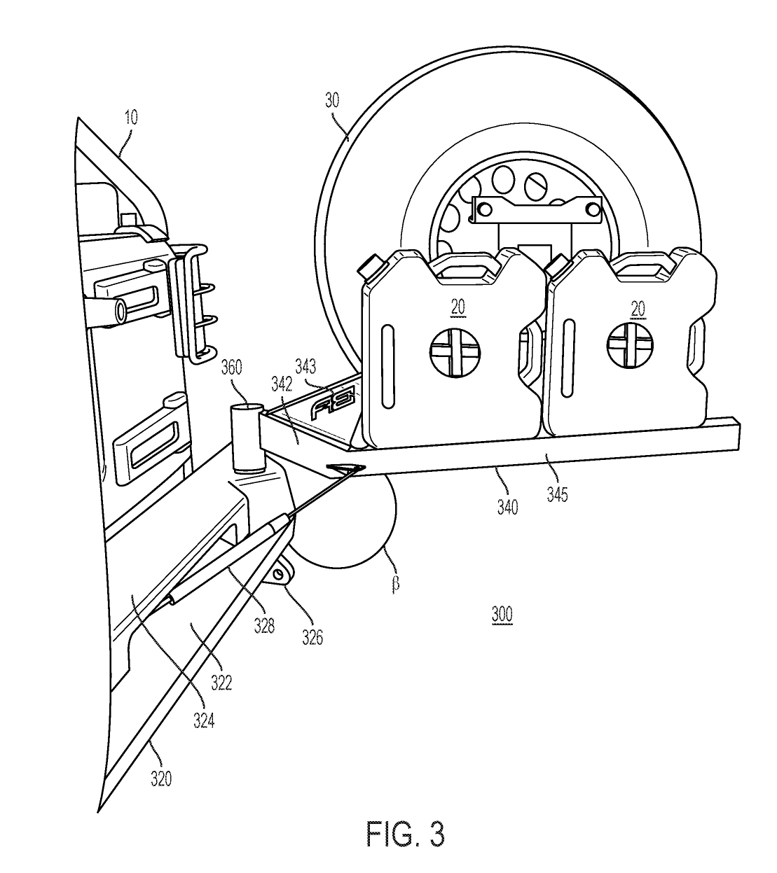

FIG. 3 is a perspective view illustrating a swing arm of a carrier assembly according to another embodiment of the present invention. As illustrated in FIG. 3, a carrier assembly 300 includes a bumper assembly 320 and an arm assembly 340. A post assembly 360 rotatably attaches the arm assembly 340 with the bumper assembly 320.

The arm assembly 340 can swing about the post assembly 360 relative to the bumper assembly 320. The bumper assembly 320 can be detachably attached to an exterior of a vehicle 10. For example, the bumper assembly 320 is detachably attached to a rear end of the vehicle 10. The bumper assembly 320 may replace a factory bumper (not shown) to a vehicle 10. The bumper assembly 320 may be attached to the rear end of the vehicle 10 at the same position and in the same manner as a factor bumper (not shown).

The bumper assembly 320 includes a first base 322 and a second base 324. The first base 322 and the second base 324 are substantially parallel with one another. The first base 322 and the second base 324 have tiered planes. For example, the first base 322 has a higher plane than the second base 324.

The bumper assembly 320 also includes at least one built-in strike plate or shackle mount 326. The mount 326 may extend from a side under the second base 324. With the first and second bases 322 and 324 having tiered planes and by incorporating the mount 326 or another type of mounting mechanisms from an underside of the bumper assembly 320, clearance can be provided for the objects to be attached to or carried through the shackle mounts or another type of mounting mechanisms from the arm assembly 340.

The arm assembly 340 includes multiple carrier capacities to provide flexible and large auxiliary carrying capabilities. For example, the arm assembly 340 may simultaneously hold one or more auxiliary gasoline cans 20 on the front side of the arm assembly 340, and a spare tire 30 on the rear side of the arm assembly 340.

The arm assembly 340 includes a first arm 342, and a side plate 343. The side plate 343 extends substantially vertically from the first arm 341. The first arm 342 and the side plate 343 are suspended above the first base 322 and the second base 324 of the bumper body assembly 320. The rear surface of the side plate 343 may provide a display surface for displaying a logo or decal. When the arm assembly 340 is in the close position (not shown), the side plate 343 extends at an angle relative to the first base 322 and the second base 324 of the bumper body assembly 320. The side plate 343 preferably extends from an outer edge of the first base 322 of the bumper body assembly 320, across the length of the second base 324 of the bumper body assembly 320, to an outer edge of the second base 324 of the bumper body assembly 320. In addition, the angling of the side plate 343 provides additional space for a front-side carrier of the arm assembly 340.

The arm assembly 340 further includes a second arm 345. The second arm 345 is a primary arm of the arm assembly 340. The second arm 345 is suspended above the first base 322 and the second base 324 of the bumper body assembly 320. A first end of the primary arm 345 is attached to the first arm 342 and the side plate 343.

FIG. 3 illustrates the carrier assembly 300 in an open position. When the carrier assembly 300 is in an open position, the arm assembly 340 swings about the post assembly 360 and away from the bumper body assembly 320. In an embodiment, the arm assembly 340 can swing about the post assembly 360 at an angle β. The angle β is between 0° to ˜90°, for example, 90° and 100°. In another embodiment, the angle β is between 0° to more than 100°, for example 120°.

The bumper assembly 320 may further include a retractor 328. The retractor 328 keeps the arm assembly 340 with a tension, as the arm assembly 340 swings about the post assembly 360 and away from the bumper body assembly 320. In addition, the retractor 328 holds the arm assembly 340 at the fully open position, when the rotation angle β is at maximum. The retractor 328 may include a spring mechanism (not shown) that retracts the arm assembly 340 toward back to the bumper body assembly 320. The spring mechanism (not shown) may retract the arm assembly 340 in a controlled manner. The retractor 328 is retrieved and stays within the bumper assembly 320, when the carrier assembly 300 is in the closed position and when the second arm 345 is aligned substantially parallel to the first base 322.

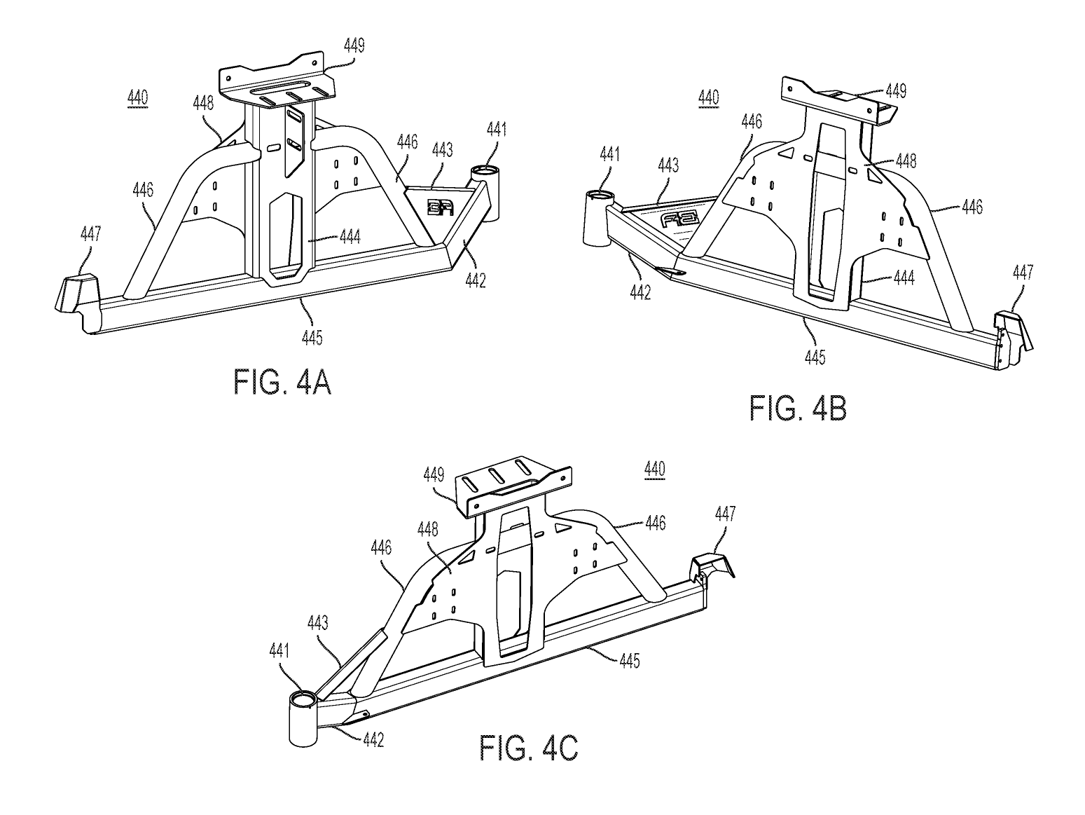

FIG. 4A, FIG. 4B, and FIG. 4C are perspective views illustrating an arm assembly for a carrier assembly according to an embodiment of the present invention. As illustrated in FIGS. 4A-4C, an arm assembly 440 includes a post receptor 441, a first arm 442, a side plate 443, a beam 444, a second arm 445, and two side arms 446. The post receptor 441, the first arm 442, the side plate 443, the beam 444, the second arm 445, and the side arms 446 move as one unit. The post receptor 441 is at a first end of the arm assembly 440. The post receptor 441 preferably has a cylindrical-like shape, and a generally hollow-center for receiving a post pin (not shown). The post receptor 441 can be rotatably attached to a bumper (not shown). When the arm assembly 440 rotates about a bumper (not shown), the post receptor 441, the first arm 442, the side plate 443, the beam 444, the second arm 445, and the two side arms 446 also swing relative to the bumper (not shown) as one unit.

The first arm 442 is connected to the post receptor 441 and the second arm 445. The first arm 442 extends between the post receptor 441 and the second arm 445 at a non-zero angle. For example, when the second arm 445 is aligned substantially parallel to a first base of a bumper (not shown), the first arm 442 would be seen to be non-parallel to the first base of the bumper (not shown). The first arm 442 may extend between the post receptor 441 and the second arm 445 at an angle between 5° to 30°. In another embodiment, the first arm 442 may extend between the post receptor 441 and the second arm 445 at an angle between 20° to 70°.

The rear surface of the side plate 443 may provide a display surface for displaying a logo or decal. The side plate 443 may have a triangular-like or a trapezoid-like surface shape. The side plate 443 is connected to the first arm 442, the second arm 445 and one of the side arms 446. When the second arm 445 is aligned substantially parallel to a first base of a bumper (not shown), the side plate 443 would be seen to be an angled or inclining surface relative to a first base of the bumper (not shown). The side plate 443 preferably extends across at least one portion of the length of the bumper (not shown). In addition, the angling of the side plate 443 provides additional space for a front-side carrier of the arm assembly 440.

The beam 444 extends substantially perpendicular from the second arm 445. Each of the two side arms 446 extends substantially vertically from the second arm 445. Each of the two side arms 446 extends between the beam 444 and the second 445. Each of the two side arms 446 may include an arc. The side arms 446 and the second arm may from a trapezoid-like contour.

The arm assembly 440 preferably includes a front side carrier 448 and a rear side carrier 449. The front side carrier 448 may include a panel that functions as an auxiliary gasoline can holder for holding one or more auxiliary gasoline cans (not shown) on the front side of the arm assembly 440. The front side carrier 448 may be a panel having plurality of openings for receiving clamps or ropes to affixed an auxiliary gasoline can on the arm assembly 440. The rear side carrier 449 may include a top plate that functions as a spare tire holder for holding a spare tire on the rear side of the arm assembly 440.

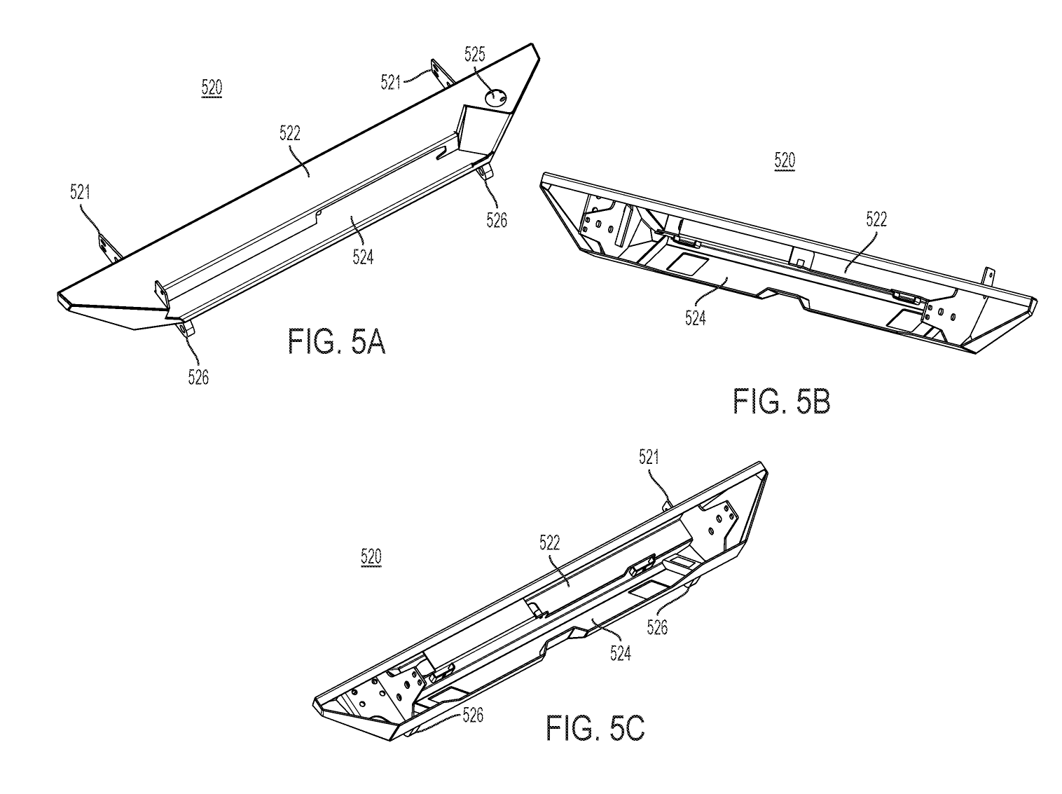

FIG. 5A, FIG. 5B, and FIG. 5C are perspective views illustrating a bumper assembly for a carrier assembly according to an embodiment of the present invention. As illustrated in FIGS. 5A-5C, a bumper assembly 520 can be detachably attached to an exterior of a vehicle (not shown). For example, the bumper assembly 520 is detachably attached to a rear end of the vehicle (not shown) through multiple bumper brackets 521. The bumper assembly 520 may replace a factory bumper (not shown) for a vehicle. The bumper assembly 520 may be attached to the rear end of a vehicle (not shown) at the same position and in the same manner as a factor bumper (not shown) would be attached to the vehicle (not shown).

The bumper assembly 520 includes a first base 522 and a second base 524. The first base 522 and the second base 524 are substantially parallel with one another. The first base 522 and the second base 524 have tiered planes. For example, the first base 522 has a higher plane than the second base 524.

The bumper assembly 520 includes a post cavity 525 for a post kit (not shown). In addition, the internal of the bumper assembly 520 may be open or hollow portions to accommodate a post kit (not shown) for rotatably connecting to an arm assembly (not shown) or to accommodate a retractor (not shown) for regulating the movement of an arm assembly (not shown).

The bumper assembly 520 also includes one or more built-in strike plates or shackle mounts 526. The mounts 526 may extend from a side under the second base 524. With the first and second bases 522 and 524 having tiered planes and by incorporating the mounts 526 or another type of mounting mechanisms under the plane of the second base 524, clearance can be provided for the objects to be attached to or carried through the shackle mounts or another type of mounting mechanisms from an arm assembly (not shown).

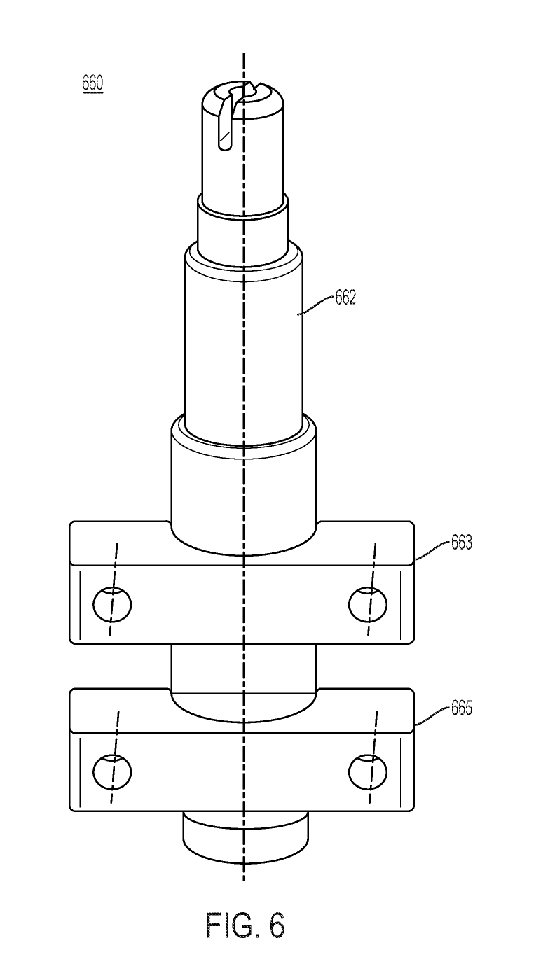

FIG. 6 is a perspective view illustrating a post for a carrier assembly according to an embodiment of the present invention. In FIG. 6, a post 660 includes a main body 662, a first flange portion 663 and a second flange portion 665. The main body 662 may have a generally cylindrical shape. For example, different portions of the main body 662 may have cylinders with different diameters. The main body 662 may have a tiered profile.

The first flange portion 663 and the second flange portion 665 may be substantially perpendicular to the main body 662. The first flange portion 663 and the flange portion 665 may extend from the widest portion of the main body 662.

The post 660 may be a part of a post assembly that includes a post receptor and a post cavity. The post may be anchored within a post cavity, to allow rotation in the post receptor. For example, when the post 660 is a part of a post assembly that includes the post receptor 441 (shown in FIG. 4A, 4B, or 4C) and the post cavity 525 (shown in FIG. 5A, 5B, or 5C), the post 660 may be positioned through the post cavity 525 and within the post receptor 441 to permit rotation of the post receptor 441 about the post 660.

It will be apparent to those skilled in the art that various modifications and variations can be made in the carrier assembly of embodiments of the invention without departing from the spirit or scope of the invention. Thus, it is intended that embodiments of the invention cover the modifications and variations of this invention provided they come within the scope of the appended claims and their equivalents.

What is claimed:

1. A device, comprising:
a bumper body assembly, the bumper body assembly including a first base, a second base, and a first cavity, the first base being higher than the second base;
a swing arm assembly, the swing arm assembly including a rack providing a front-side carrier and a rear-side carrier; and
a post kit, the post kit corresponding to the first cavity in the bumper body assembly,
wherein the swing arm assembly is detachably attached to the bumper body assembly with the post kit and the swing arm assembly is swingable about the post kit and swingable away from the bumper body assembly.

2. The device of claim 1, wherein the swing arm assembly is swingable between zero to ninety degrees or more away from the bumper body assembly.

3. The device of claim 1, wherein the post kit fits into the first cavity of the bumper body assembly, and stands substantially perpendicularly to the upper surface of the first base of the bumper body assembly.

4. The device of claim 1, wherein the swing arm assembly includes a first arm, a first plate and two side arms, the first plate being substantially vertical to the first base of the bumper body assembly, wherein when the swing arm assembly is in a closed position, the first arm is substantially parallel to the first base of the bumper body assembly and suspended above the second base of the bumper body assembly.

5. The device of claim 1, wherein as the swing arm assembly swings about the post kit, the first plate remains substantially vertical to the first base of the bumper body assembly.

6. The device of claim 1, wherein the front-side carrier of the swing arm assembly includes an auxiliary gasoline can holder, and the rear-side carrier of the swing arm assembly includes a spare tire holder.

7. The device of claim 1, further comprising:
a spring retraction mechanism in the bumper body assembly for retracting the swing arm assembly toward the bumper body assembly.

8. The device of claim 1, further comprising:
a locking mechanism in the bumper body assembly for locking the swing arm assembly with the bumper body assembly when the swing arm assembly is in a closed position.

9. The device of claim 1, further comprising,
a reclined side wall between the first base and the second base, wherein when the device is attached to a vehicle, the first base is closer to a vehicle main body than the second base.

10. A device, comprising:
a bumper, the bumper including a first base, a second base, and a first cavity, the first base being higher than the second base and the first cavity in a first end of the bumper;
a pivoting arm assembly, the pivoting arm assembly including a rack providing a front-side carrier and a rear-side carrier; and
a post, the post corresponding to the first cavity in the bumper,
wherein the pivoting arm assembly is detachably attached to the bumper with the post and the pivoting arm assembly pivots about the post and away from a second end of the bumper.

11. The device of claim 10, wherein the pivoting arm assembly pivots between zero to ninety degrees or more away from the second end of the bumper.

12. The device of claim 10, wherein the post fits into the first cavity of the bumper, and stands substantially perpendicularly to the upper surface of the first base of the bumper.

13. The device of claim 10, wherein the pivoting arm assembly includes a first arm, a first plate and two side arms, the first plate being substantially vertical to the first base of the bumper body assembly, wherein when the swing arm assembly is in a closed position, the first arm is substantially parallel to the first base of the bumper body assembly and suspended above the second base of the bumper body.

14. The device of claim 10, wherein as the pivoting arm assembly pivots away from the second end of the bumper, the first plate remains substantially vertical relative to the first base of the bumper.

15. The device of claim 10, wherein the front-side carrier of the pivoting arm assembly includes an auxiliary gasoline can holder, and the rear-side carrier of the pivoting arm assembly includes a spare tire holder.

16. The device of claim 10, further comprising:
a spring retraction mechanism in the bumper for retracting the pivoting arm assembly back toward to the second end of the bumper.

17. The device of claim 10, further comprising:
a locking mechanism in the bumper for locking the pivoting arm assembly with the bumper when the pivoting arm assembly is aligned with the second end of the bumper.
